(19) United States
(12) Patent Application Publication
(10) Pub. No.: US 2008/0032080 A1
(43) Pub. Date: Feb. 7, 2008

(54) Thermoplastic, moldable polymer composition and dynamic vulcanizates thereof

(75) Inventors: Roger W. Faulkner, Cambridge, NY (US); James F. Reilly, Manlius, NY (US); Haruhisa Masuda, Osaka (JP); Mitsuhiro Otani, Osaka (JP); Tomihiko Yanagiguchi, Osaka (JP); Toshiki Ichisaka, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN AMERICA, INC., Orangeburg, NY (US)

(21) Appl. No.: 11/712,433

(22) Filed: Mar. 1, 2007

Related U.S. Application Data
(63) Continuation-in-part of application No. 11/658,867.
(60) Provisional application No. 60/778,189, filed on Mar. 2, 2006.

(30) Foreign Application Priority Data
Nov. 26, 2004 (JP) 2004-342772

(51) Int. Cl. F16L 11/04; C08L 53/00

(52) U.S. Cl. 428/36.91; 524/505; 525/96

(57) ABSTRACT

A thermoplastic, moldable, millable, extrudable composition of matter involving at least three polymeric components: a fluoroelastomer, an ETFE (ethylene/tetrafluoroethylene alternating copolymer, which may optionally contain one or more comonomers in minor amounts to alter crystallinity and melting temperature) fluoroplastic, and a block fluoropolymer containing at least one fluoroelastomer block and at least one ETFE block. The fluoroelastomer component and optionally the fluoroelastomer portion of the block fluoropolymer are crosslinked in a dynamic vulcanization process. Also disclosed are multilayer articles in which the aforesaid fluoro-TPV is adhered to an ETFE plastic layer. These bonded multilayer objects may include injection-molded parts that are either co-injected with both ETFE and fluoro-TPV layers, or insert molding jobs in which a previously molded ETFE insert is placed into a mold and surrounded by fluoro-TPV; and also multilayer co-extruded products such as hoses in which a fluoro-TPV layer is extruded against an ETFE layer.

### CROSS-REFERENCE TO RELATED APPLICATIONS

This application is a continuation-in-part of application Ser. No. 11/658,867 which is a 371 of PCT/JP2005/021667 filed Nov. 25, 2005 and which continuation-in-part claims benefit from U.S. Provisional Application No. 60/778,189 filed Mar. 2, 2006, the above-noted applications incorporated herein by reference in their entirety.

### BACKGROUND OF THE INVENTION

1. Field of the Invention

The present invention relates to a thermoplastic, moldable polymer composition and a dynamic vulcanizate thereof comprising a fluororesin, a crosslinked fluororubber and a fluorine-containing thermoplastic elastomer, and a molded or extruded article such as a fuel permeation-resistant hose formed from the thermoplastic polymer composition.

2. Description of the Related Art

Fluoroelastomers are employed for various uses in the fields of automobiles, semiconductors and other industries, since the fluoroelastomers have excellent properties such as heat resistance, chemical resistance and low compression set.

On the other hand, crystalline thermoplastics are employed in broad fields such as automobiles, industrial machines, office automation equipment and electrical and electronic equipment since crystalline thermoplastics are excellent in properties such as sliding properties, heat resistance, chemical resistance, weather resistance and electrical properties.

For the purpose of improving processability and permeation resistance of fluoroelastomers or for the purpose of imparting flexibility to crystalline thermoplastics, polymer alloys of a fluoroelastomer and a crystalline thermoplastic have been studied. However, general compatibility between a fluoroelastomer and a crystalline thermoplastic is poor, and simple melt-kneading of the fluoroelastomer and the crystalline thermoplastic only generates defective, unstable dispersion in which the morphology of the fluoroelastomer and crystalline thermoplastic domains varies substantially with processing history, and problems such as peeling among layers and lowering of strength occur in such binary melt blends. An important example of such binary melt blends of a crystalline thermoplastic and a fluoroelastomer are various blends of ETFE thermoplastic with fluoroelastomers. In order to solve these problems with ETFE/fluoroelastomer melt blends, one approach is to crosslink the blends after mixing, as for example by ionizing radiation in the presence of an effective co-agent such as triallylisocyanurate (“TAIC”). In some cases, crosslinking via electron beam can stabilize ETFE/fluoroelastomer blends so as to give good properties for some applications, such as wire coatings. A particular crystalline thermoplastic-fluoroelastomer block copolymer similar to ETFE/FKM Polymer A (used in examples of the present invention) has been used either as a substitute for ETFE/fluoroelastomer blends, or as a compatibilizer in three-component blends (for example, see JP-2001-501982 and JP-A-6-25500).

However, the inventions described in JP-2001-501982 and JP-A-6-25500 describe systems that still must be crosslinked by ionizing radiation (typically from electron beams) in order to achieve good properties; such electron beam crosslinking can be readily applied to wire insulation, but it is difficult to use to produce more complicated shapes such as multilayer hose or molded goods; moreover, after processing the whole of the obtained rubber/plastic composition is cross-linked, thus, the invention has a problem that the obtained ETFE/fluoroelastomer blend cannot be melt-molded and recycled any more.

From a different aspect, triblock fluoro-TPEs (crystalline thermoplastic-fluoroelastomer block copolymers) comprised of two ETFE hard blocks at the chain ends and a soft fluoroelastomer center block can be prepared by the methods described in U.S. Pat. No. 4,158,678. These polymers are further described in chapter 30 of the book Modern Fluoropolymers, 1997, edited by John Schiers. (One of the authors of this chapter, Masayoshi Tatemoto, is an inventor of U.S. Pat. No. 4,158,678.)

ETFE/FKM Polymers A and B, which are used extensively in examples herein, are triblock polymers prepared as per U.S. Pat. No. 4,158,678 in which there are alternating “hard” and “soft” blocks, similar morphologically to SBS (triblock polymers of polystyrene/polybutadiene/polystyrene) or SEBS (triblock polymers of polystyrene/polyethylene-co-butadiene/polystyrene, derived from hydrogenation of SBS polymers) triblock copolymers such as KRATON™ TPEs, for example. One difference between SBS polymers and the like compared to the ETFE/FKM/ETFE triblock polymers is that the hard block is an amorphous plastic in the case of SBS, whereas it is a crystalline or at least crystallizable polymer that is used above its glass transition temperature. The following describes these triblock fluoropolymers used in the examples in detail:
ETFE/FKM Polymer A is an ETFE/FKM/ETFE triblock polymer in which the center FKM block is an FKM terpolymer of vinylidene fluoride (“VDF”), hexafluoropropene (“HFP”), and tetrafluoroethylene (“TFE”), such that the FKM center block is about 71% fluorine by weight, and the number average molecular weight of the center block is about 100,000 to 150,000. The hard outer blocks of ETFE/FKM Polymer A comprise about 15% by weight of the total polymer. The melt viscosity of the particular samples of ETFE/FKM Polymer A used herein are as shown in FIG. 1, and the melt flow index at 297° C., with a 10-kg load is about 22.
ETFE/FKM Polymer B is an ETFE/FKM/ETFE triblock polymer in which the center FKM block is an FKM terpolymer of vinylidene fluoride (“VDF”), hexafluoropropene (“HFP”), and tetrafluoroethylene (“TFE”), such that the FKM center block is about 71% fluorine by weight, and the number average molecular weight of the center block is about 100,000 to 150,000. The hard outer blocks of ETFE/FKM Polymer B comprise about 25% by weight of the total polymer. The melt viscosity of the particular sample of ETFE/FKM Polymer B used herein are shown in FIG. 1, and the melt flow index at 297° C., with a 10-kg load is about 6.

Compared to other available multiblock elastomeric fluoropolymers, ETFE/FKM Polymer A and ETFE/FKM Polymer B are much more resistant to fuels, oxidation, and heat aging. These polymers are approximately 65-75 Shore A durometer after molding or extrusion. The main difference between them is in the relative weight fraction of the rubbery FKM center block versus the hard ETFE end-blocks (ETFE is an alternating copolymer of ethylene and tetrafluoroethylene, which may also contain minor amounts of comonomers to modify polymer properties); ETFE/FKM Polymer A has about 85% by weight fraction rubbery domain, whereas ETFE/FKM Polymer B has about 75% by weight FKM. Consequently, ETFE/FKM Polymer A has slightly lower hardness (˜67 Shore A) versus ETFE/FKM Polymer (˜73 Shore A). These triblock fluoro-TPEs achieve very good tensile strength compared to prior art FKM/crystalline thermoplastic dynamic vulcanizates, such as the materials of U.S. Pat. No. 6,624,251 for example, but have proved difficult to injection mold, and break up into powder through massive stress-cracking in standard compression set tests at moderately elevated temperatures, regardless of how the specimens are molded.

U.S. Pat. No. 6,207,758 also describes fluoroplastic-fluoroelastomer block copolymers that are of the A-B-A triblock type, analogous to the well-known KRATON™ polymers from Shell, but dissimilar in that the end blocks must crystallize to harden (as is also the case for ETFE/FKM Polymer A and ETFE/FKM polymer B).

One potential way to address the deficiencies of ETFE/FKM Polymer B and ETFE/FKM Polymer A is to chemically modify the composition of the constituent polymer blocks; see for example U.S. Pat. No. 6,706,819, in which polar groups are used to modify the multiblock fluoro-TPEs to make the polymers more suitable as materials for laser printer/photocopier fuser rolls. In principle, polymer composition and morphology can be modified in this way to optimize block copolymers for a variety of different applications, but it is expensive to introduce new polymers for each new application.

Another way to make fluoroplastic-fluoroelastomer block copolymers in general is via dynamic vulcanization; see for example U.S. Pat. Nos. 4,348,502; 4,130,535; 4,173,556; 4,207,404; 4,409,365; 6,020,427; 6,066,697; 6,084,031; 6,329,463 and 6,503,985. Dynamic vulcanization is a particularly flexible method in that there are many different, commercially available elastomers that can be dynamically cured in a wide variety of different thermoplastics. In essence, dynamic vulcanizates are dispersions of crosslinked elastomer particles in a thermoplastic matrix. Dynamic vulcanization is only one method to obtain such dispersions of crosslinked elastomer particles in a thermoplastic matrix; another method involves core-shell latexes.

U.S. Pat. No. 6,153,681 describes core-shell latexes which act as thermoplastic elastomers. These materials have either a core fluoroelastomeric polymer portion surrounded by a crystalline fluoroplastic polymer portion or, a core fluoroplastic polymer portion surrounded by a fluoroelastomeric polymer portion (surprisingly, both versions worked as TPEs, elastomer core and elastomer shell). There is significant grafting between the two layers, and an indeterminate degree of crosslinking occurs as the fluoroelastomer polymerizes. These fluorinated fluoroplastic-fluoroelastomer block copolymers reportedly have excellent physical properties, though they are rather stiff compared to typical fluoroelastomers. They can reportedly be used to make moldings such as gaskets and seals, but no data on compression set or compression relaxation is presented in the patent to validate this, nor is there any information presented on injection moldability.

U.S. Pat. No. 6,066,697 describes thermoplastic compositions containing crosslinked particulate elastomers in a flowable matrix of fluorine containing thermoplastics. This thermoplastic vulcanizate is prepared by dynamically vulcanizing a rubber within a blend that comprises the rubber, a fluorine-containing thermoplastic, and a vulcanizing agent; wherein the rubber is selected from nitrile rubber, hydrogenated nitrile rubber, amino-functionalized nitrile rubber, acrylonitrile-isoprene rubber, and mixtures thereof.

### SUMMARY OF THE INVENTION

An object of the invention is to provide a thermoplastic, moldable polymer composition and dynamic vulcanizate thereof, which is flexible, is capable of melt-molding and has excellent heat resistance, chemical resistance, oil resistance, and fuel barrier properties. Further, another object of the invention is to provide a molded or extruded article such as a fuel permeation-resistant hose formed from the thermoplastic polymer composition and/or dynamic vulcanizate thereof.

Generally, the present invention relates to a thermoplastic composition comprising a fluororesin (A) comprising a fluorine-containing ethylenic polymer (a), a crosslinked fluororubber (B) in which at least a part of at least one kind of fluororubber (b) is cross-linked, and a fluorine-containing thermoplastic elastomer (C). Preferably, the crosslinked fluororubber (B) is a rubber wherein the fluororubber (b) is cross-linked dynamically in the presence of the fluororubber (A), the fluorine-containing thermoplastic elastomer (C) and a crosslinking agent (D) under melting conditions. Furthermore, the fluorine-containing thermoplastic elastomer (C) preferably comprises at least one kind of elastomeric polymer segment (c-1) and at least one kind of non-elastomeric polymer segment (c-2), and at least either of the elastomeric polymer segment (c-1) and the non-elastomeric polymer segment (c-2) is a fluorine-containing polymer segment.

In more detail, the compositions of this invention contain FKM, ETFE, and one or more block polymers of ETFE and FKM. The block polymers can be triblock polymers such as ETFE/FKM Polymer A or ETFE/FKM Polymer B as described above, the block polymers of U.S. Pat. No. 6,207,758 or 6,706,819, block polymers formed in situ through chemical reactions of reactive ETFE end-groups (such as those described in U.S. Pat. Nos. 6,538,084; 6,680,124; 6,740,375; 6,881,460; and 6,893,729) with FKM, or diblock ETFE/FKM polymer compatibilizers formed by the method of U.S. Pat. No. 4,158,678. The total amount of ETFE plastic (including the ETFE blocks of the block polymers) comprises about 20-50% of the total polymer weight present in the composition; most of the remaining about 80-50% of the total polymer is comprised of FKM fluoroelastomer (including the FKM blocks of the block polymers), though up to about 2% of the total polymer can also comprise various polymeric processing aids. The FKM components of the present invention are typically crosslinked in a dynamic curing process at temperatures of about 230-280° C., such that the crosslinked FKM contains about 2-6 millimoles of crosslinks per 100 grams of FKM. Crosslinking can be accomplished by any known means that is effective for crosslinking the particular fluoroelastomers, including peroxides with coagents, diamines, polyamines, or bisphenols for example; we will refer to this composition as a “fluoro-TPV,” short for fluoropolymer thermoplastic vulcanizate.

Thus, in a first aspect, the present invention relates to a thermoplastic, moldable composition comprising a fluororesin (A) containing a fluorine-containing ethylenic polymer (a), a crosslinked fluororubber (B) including a fluororubber (b), at least part of the fluororubber (b) being chemically crosslinked, and a fluorine-containing thermoplastic elastomer (C). Preferably, most of the fluororubber (b) is chemically crosslinked. The fluorine-containing ethylenic polymer (a) comprises an ETFE copolymer, the fluororubber (b) comprises a FKM copolymer, and the fluorine-containing thermoplastic elastomer (C) is a block polymer comprising an elastomeric polymer segment (c-1) and a non-elastomeric polymer segment (c-2). The elastomeric polymer segment (c-1) comprises a FKM copolymer and the non-elastomeric polymer segment (c-2) comprises an ETFE copolymer. Furthermore, the composition contains about 50-80 wt % of FKM copolymer, including constituent segments of said block polymer (meaning (B)+(C-1)), and contains about 20-50 wt % of ETFE copolymer, including constituent segments of the block polymer meaning ((A)+(C-2)), as a fraction of the total polymer contained in the composition.

In a preferred embodiment, the crosslinked fluororubber (B) is obtained by dynamically crosslinking the fluororubber (b) in the presence of the fluororesin (A), the fluorine-containing thermoplastic elastomer (C) and a crosslinking agent (D) under melt mixing conditions.

In yet another preferred embodiment, the thermoplastic, moldable polymer composition comprises up to 2 wt % of polymeric processing aids and compounding ingredients.

In yet another preferred embodiment, the thermoplastic, moldable composition contains about 0.5-1.0 wt % of a processing aid which is a copolymer of methyl-acrylate and/or methyl-methacrylate and butyl acrylate, as a fraction of the total polymer contained in the composition.

In yet another preferred embodiment, the thermoplastic, moldable composition further contains an oligomeric ester internal lubricant in an amount of about 0.01-0.10 wt % of the entire composition.

In yet another preferred embodiment, the thermoplastic, moldable composition contains about 5-60 wt % of an ETFE/FKM/ETFE triblock polymer as a fraction of the total polymer contained in the composition, wherein at least most of the FKM copolymer constituting the fluororubber (b) and a portion of the FKM center block of the ETFE/FKM/ETFE triblock polymer is crosslinked by a bisphenol or polyamine cure system.

In yet another preferred embodiment, most of the ETFE constituting the fluorine-containing ethylenic polymer (a) comprises ETFE having a reactive end-group.

In yet another preferred embodiment, the thermoplastic elastomer (C) comprises an ETFE/FKM diblock polymer.

In yet another preferred embodiment, the thermoplastic elastomer (C) comprises an ETFE/FKM diblock polymer in an amount of about 1-10 wt % as a fraction of the total polymer contained in the thermoplastic, moldable composition.

In yet another preferred embodiment, at least most of the FKM copolymer constituting the fluororubber (b) and a portion of the FKM block of the ETFE/FKM diblock polymer is crosslinked by a bisphenol or a polyamine cure system.

In yet another preferred embodiment, at least most of the FKM copolymer constituting said fluororubber (b) and a portion of the FKM copolymer constituting thermoplastic elastomer (C) is crosslinked by a bisphenol cure system in which most or all of the bisphenol is bisphenol sulfone.

In yet another preferred embodiment, the crosslinking of the FKM copolymer is catalyzed by ethyltriphenylphosphonium iodide.

In a second aspect, the present invention relates to a fuel permeation-resistant hose including a layer comprising a fluoropolymer thermoplastic vulcanizate comprising a fluororesin (A) containing a fluorine-containing ethylenic polymer (a), a crosslinked fluororubber (B) including a fluororubber (b), at least most of the fluororubber (b) being chemically crosslinked, and a fluorine-containing thermoplastic elastomer (C). The fluorine-containing ethylenic polymer (a) comprises an ETFE copolymer, said fluororubber (b) comprises a FKM copolymer, and said fluorine-containing thermoplastic elastomer (C) is a block polymer comprising an elastomeric polymer segment (c-1) and a non-elastomeric polymer segment (c-2). The elastomeric polymer segment (c-1) comprises a FKM copolymer and the non-elastomeric polymer segment (c-2) comprises an ETFE copolymer, and the vulcanizate contains about 50-80 wt % of FKM copolymer and contains about 20-50 wt % of ETFE copolymer, including constituent segments of said block polymer, as a fraction of the total polymer contained in the vulcanizate.

In a preferred embodiment, the fuel permeation-resistant hose further includes an outer ETFE layer.

In yet another preferred embodiment, the fuel permeation-resistant hose is prepared by co-extruding the ETFE layer with the fluoropolymer thermoplastic vulcanizate.

In yet another preferred embodiment, the fuel permeation-resistant hose further comprising a layer of nylon extruded over the ETFE layer.

In yet another preferred embodiment, the fuel permeation-resistant hose further comprises a layer of a polyester-based block polymer thermoplastic elastomer extruded over the ETFE layer.

In yet another preferred embodiment, the fuel permeation-resistant hose further comprises a layer of a thermoset elastomer extruded over the ETFE layer.

In a third aspect, the present invention also provides a composition having a reduced flex modulus obtained by melt blending the composition of the above-described first aspect with additional ETFE.

The present invention also provides a dynamic vulcanizate of a thermoplastic having a melting or minimum practical melt processing temperature of about 220-270° C. with FKM, wherein the FKM is dynamically vulcanized to crosslink the same via a bisphenol cure system catalyzed by an onium salt with a counter anion of low nucleophilicity.

In a preferred embodiment, crosslinking of the FKM is via a bisphenol cure system in which most or all of the bisphenol is bisphenol sulfone.

In yet another preferred embodiment, crosslinking of the FKM is catalyzed by ethyltriphenylphosphonium iodide.

In yet another preferred embodiment, the thermoplastic comprises polyphenylene sulfide.

In yet another preferred embodiment, the thermoplastic comprises a polyamide.

One major area in which the fluoro-TPVs of this invention are useful is in fuel systems, for flexible components that have heretofore usually been made of fluoroelastomers. In this application, it is particularly useful that the ETFE-based fluoro-TPVs of this invention adhere very well to ETFE plastic, as in a multilayer extruded hose in which the fluoro-TPV layer is next to an ETFE barrier layer. Simple coextrusion suffices to obtain good adhesion between the fluoro-TPV and the ETFE layer, unlike various prior art multilayer hose constructions in which either special processing or addition of special adhesion promoters is required to obtain adhesion between fluoroelastomeric layers and fluoroplastics (see for example U.S. Pat. No. 5,320,888).

Another major area in which the compositions of this invention are useful is in applications where extreme chemical resistance is needed, as in wetted pump and/or valve components in contact with strong oxidizers such as nitric acid, halogens and/or hypochlorite solutions. Another application area is in rotary seals.

### BRIEF DESCRIPTION OF THE DRAWINGS

Other objects, features and advantages will be apparent to those skilled in the art from the following description of the preferred embodiments and the accompanying drawings, in which:

FIG. 1 is a plot of capillary rheometry on ETFE polymers and ETFE/FKM block polymers (raw materials) used in the Examples, useful in understanding the invention;

FIG. 2 is a plot of capillary rheometry that was run on examples of treated and untreated ETFEs (ETFE #1+FKM curatives), useful in understanding the invention;

FIG. 3 is another plot of capillary rheometry that was run on examples of treated and untreated ETFEs (ETFE #2+FKM curatives), useful in understanding the invention;

FIG. 4 is a Brabender trace of another dynamic vulcanization (curing with 1.32 phr Bisphenol AF), useful in understanding the invention; and

FIG. 5 is a Brabender trace of a dynamic vulcanization (curing with 1.2 phr Bisphenol sulfone), useful in understanding the invention;

FIG. 6 is a plot of capillary rheometry on a fluoro-TPV of this invention, with and without various processing aids, useful in understanding the invention.

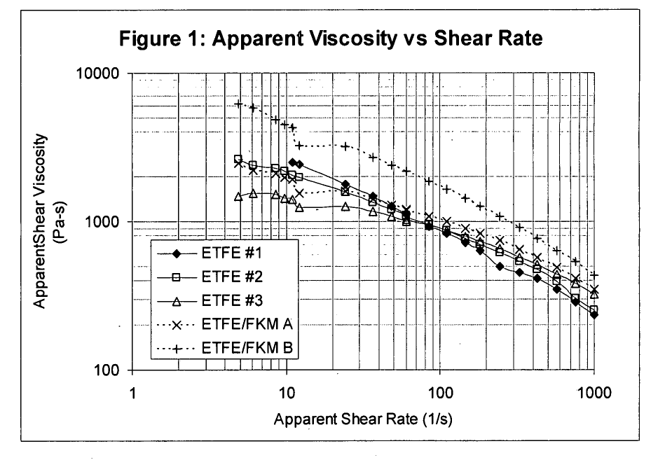

### DETAILED DESCRIPTION OF THE PREFERRED EMBODIMENTS

As used herein, “FKM polymer” means a copolymer of vinylidene fluoride (“VDF”) and hexafluoropropene (“HFP”), and depending on need and application, may contain additional comonomers such as tetrafluoroethylene (“TFE”).

The FKM copolymer preferably contains from 25 to 85 mol %, and more preferably 50 to 80 mol % of units derived from VDF and from 75 to 15 mol % and preferably 50 to 20 mol % of units derived from HFP and other comonomers copolymerizable with VDF and HFP.

In addition to the FKM copolymer, the fluororubber (b) may include, for example, perfluoro fluororubbers such as a TFE/perfluoro(alkyl vinyl ether) (“PAVE”) copolymer, a TFE/HFP/PAVE copolymer and the like.

The elastomeric polymer segment (c-1) preferably contains TFE/VDF/HFP in a ratio of 0 to 35/40 to 90/5 to 50% by mole. The ETFE copolymer of non-elastomeric segment (c-2) preferably contains TFE/ethylene in a ratio of 20 to 80/80 to 20% by mole.

As used herein, “ETFE polymer” means a copolymer of ethylene and tetrafluoroethylene, and which may also contain minor amounts of other comonomers as might be needed to modify polymer properties. A molar ratio of TFE unit and ethylene unit is preferably 20:80 to 90:10, more preferably 62:38 to 90:10, particularly preferably 63:37 to 80:20. A copolymer of alternating TFE and ethylene units may also be used. Other comonomers constituting the EFTE polymer are not particularly limited so long as the comonomers are copolymerizable with TFE and ethylene, and may include, for example, various fluorine-containing vinyl monomers in a total amount of generally up to about 10 mol % of the ETFE polymer.

In the thermoplastic, moldable composition of the invention, at least part of the fluororubber (b) which comprises a FKM copolymer is chemically crosslinked. In certain applications, most of the fluororubber (b) is chemically crosslinked. The degree of crosslinking can be adjusted by introducing more or less crosslinking sites into the fluororubber (b) using techniques well known to those skilled in this field of art. For example, comonomers which introduce a crosslinking site may be introduced into the fluororubber (b) such as monomers containing an iodine atom, a bromine atom and a double bond, a chain transfer agent, and modified monomers such as known ethlynically unsaturated compounds.

In a preferred embodiment, the composition contains an ETFE/FKM/ETFE triblock polymer, where at least most of the FKM copolymer constituting the fluororubber (b) and a portion of the FKM center block of the ETFE/FKM/ETFE triblock polymer is crosslinked. In another preferred embodiment, the composition contains an ETFE/FKM diblock polymer where at least most of the FKM copolymer constituting the fluororubber (b) and a portion of the FKM block of the ETFE/FKM diblock polymer is crosslinked.

In yet other preferred embodiments, crosslinking is catalyzed by an onium salt with a counter anion of low nucleophilicty, such as iodide and methosulfate counter anions contributing to improved scorch delay.

As discussed in greater detail below, the crosslinking agent (D) can be optionally selected depending on the kind of fluororubber (b) to be crosslinked and melt-kneading conditions. The amount of the crosslinking agent (D) is preferably 0.1 to 10 parts by weight based on 100 parts by weight of the fluororubber (b), and more preferably 0.3 to 5 parts by weight.

In a preferred embodiment, and as discussed in greater detail below, the crosslinked fluororubber (B) is obtained by dynamically crosslinking the fluororubber (b) in the presence of the fluororesin (A), the fluorine-containing thermoplastic elastomer (C) and a crosslinking agent (D) under melting conditions (i.e., dynamic vulcanization).

Under melting conditions means under a temperature where the fluororesin (A), the fluororubber (b) and the fluorine-containing thermoplastic elastomer (C) are melted. The melting temperature varies depending on glass transition temperatures and/or melting points of the respective fluororesin (A), fluororubber (b) and fluorine-containing thermoplastic elastomer (C), and is preferably 120° to 330° C., more preferably 130° to 320° C. When the temperature is less than 120° C., dispersion between the fluororesin (A) and the fluororubber (b) tends to be rough, and when more than 330° C., the rubber (b) tends to deteriorate with heat.

The obtained thermoplastic polymer composition can have a structure in which the fluororesin (A) forms a continuous phase and the crosslinked rubber (B) forms a dispersion phase, or a structure in which the fluororesin (A) and the crosslinked rubber (B) form a co-continuous phase. Of these, it is preferable for the composition to have a structure in which the fluororesin (A) forms a continuous phase and the crosslinked rubber (B) forms a dispersion phase.

Even when the fluororubber (b) forms a matrix at an initial stage of dispersion, a melt-viscosity is increased because the fluororubber (b) becomes the crosslinked rubber (B) with progress of the crosslinking reaction, and as a result, the crosslinked rubber (B) becomes a dispersion phase, or forms a co-continuous phase together with the fluororesin (A).

When such a structure is formed, the thermoplastic polymer composition of the present invention exhibits excellent heat resistance, chemical resistance and oil resistance and has excellent moldability. An average particle size of the dispersed rubbers of the crosslinked fluororubber (B) is preferably 0.01 to 30 μm, more preferably 0.1 to 10 μm. When the average particle size is less than 0.01 μm, flowability tends to lower, and when more than 30 μm, strength of the obtained thermoplastic polymer composition tends to decrease.

Also, to the thermoplastic polymer composition of the present invention, polymers such as polyethylene, polypropylene, polyamide, polyester and polyurethane, inorganic fillers such as calcium carbonate, talc, clay, titanium oxide, carbon black and barium sulfate, a pigment, a flame retardant, a lubricant, a photo-stabilizer, a weather resistance stabilizer, an antistatic agent, a ultraviolet absorber, an antioxidant, a mold-releasing agent, a foaming agent, aroma chemicals, oils, a softening agent, etc., can be added to an extent not to affect the properties of the present invention.

A preferred embodiment of the thermoplastic polymer composition of the present invention is a structure in which the fluororesin (A) forms a continuous phase and the crosslinked rubber (B) forms a dispersion phase. Also, a co-continuous phase of the fluororesin (A) with the crosslinked rubber (B) may be contained in the structure partly.

An average particle size of the dispersed rubbers of the crosslinked fluororubber (B) in the thermoplastic polymer composition of the present invention can be confirmed by any of AFM, SEM or TEM, or by a combination thereof.

Among formulations based on the ETFE/FKM triblock polymers, ETFE/FKM Polymer A and ETFE/FKM Polymer B, the best properties have been observed in dynamically cured blends containing 30-55% by polymer weight fraction ETFE/FKM Polymer A, FKM gum polymer of ˜60 Mooney, and ETFE plastic such that 30-40% of the total fluoropolymer comprises ETFE polymer or ETFE domains of the ETFE/FKM Polymer A block polymer. All curative components except the final activators are mixed with the polymers plus fillers, then the final activators are added to cause the crosslinking to occur.

It is surprising that once melt blends of ETFE and FKM are formed above the melting temperature of the ETFE, that those compositions containing less than 45% ETFE are processable on an open roll rubber mill at room temperature (i.e., without heating the mill rolls; the actual temperature of the ETFE/FKM blends during milling is 50°-90° C.), under conditions well below the melting temperature of the ETFE. It is even more surprising that these materials remain millable even after dynamic vulcanization is complete. This millability of the blends prior to dynamic curing has proved to be very useful in the preparation of dynamically vulcanized samples, and the millability after dynamic vulcanization opens up the possibility that the fluoro-TPVs of this invention can be callendered and recycled on a rubber mill.

A practical difficulty with preparing ETFE/FKM dynamic vulcanizates, especially in laboratory internal mixers such as the Brabender mixer or a Banbury mixer for example, is that the dynamic vulcanization process must occur above the melting temperature of the ETFE (220°-265° C. depending on the grade of ETFE), but conventional vulcanization reactions for FKMs are quite rapid at these temperatures. It is important that the vulcanizing chemicals be well dispersed in the ETFE/FKM melt blend before the crosslinking reactions begin, and that once the crosslinking does begin, that it not proceed too rapidly. It has proved difficult to use conventional cure systems for FKM that work well at typical cure temperatures of 170°-180° C. to perform dynamic vulcanization of FKM in ETFE at temperatures of 260°-270° C., as is typical for the fluoro-TPVs of this invention, because the crosslinking reactions are too rapid, and there is not sufficient scorch delay to allow thorough mixing of the cure system with the melt blend prior to the onset of curing.

One part of how the cure system was controlled in the present invention to achieve thorough mixing of the cure system components prior to the onset of FKM curing involves room temperature mill blending of cure system components with previously mixed ETFE/FKM “parent masterbatch” blends, which were prepared above the melting temperature of the ETFE. Thus, mill blends of MgO (activator), bisphenol (curative), and onium salt (quaternary ammonium or preferably quaternary phosphonium salts, which work as phase transfer catalysts, or “accelerators” herein) with the previously prepared ETFE/FKM melt blend parent masterbatch were separately prepared on a room temperature mill. Alternatively, the bisphenol curative and metal oxide activator can be milled together into a portion of the parent masterbatch, but in either case, the onium catalyst is isolated in an “activator masterbatch” which is prepared from the parent masterbatch at low temperature, below 120° C. These mill blended compounds all contain the same fillers and polymers as the parent masterbatch, in the same ratios, but also contain a component of the cure system. During dynamic curing, a portion of the parent masterbatch is put into the internal mixer and brought up to temperature, then the activator-containing masterbatch and the curative-containing masterbatches are added. After these are thoroughly blended, the accelerator-containing masterbatch is added. Since the activator onium salt is already dispersed in the parent masterbatch, the blending occurs rapidly. Ideally, there should be a delay of at least 30 seconds before the torque increase indicating the onset of crosslinking, to allow for thorough mixing of all components before curing begins. As will be elucidated with the examples, even when the onium accelerator is pre-blended with the parent masterbatch, the typical BTPPC (benzyltriphenylphosphonium chloride) accelerator causes too fast a crosslinking reaction, so it was essential to find a slower acting accelerator. It was determined that ETPPI (ethyltriphenylphosphonium iodide) worked very well as an accelerator for bisphenol curing in dynamic vulcanization of FKM in an ETFE matrix.

Two different bisphenol curatives, bisphenol AF (which is hexafluorobisphenol A, CAS # 1478-61-1, the most common curative for FKM) and bisphenol sulfone (4,4′-sulfonyldiphenol; also known as diphone, or bisphenol S) were also compared. Bisphenol sulfone produced a slower crosslinking reaction, which is more desirable from the standpoint of controlling dynamic vulcanization, and allowing sufficient time for the FKM phase to crosslink and break up into small particulates. Bisphenol sulfone is also substantially less expensive than bisphenol AF, and less volatile at typical dynamic vulcanization temperatures of 260-280° C.

The fluoro-TPVs of the present invention adhere very well to ETFE plastic, probably because the matrix phase of the fluoro-TPV is also ETFE plastic. Use of the fluoro-TPVs of this invention in conjunction with ETFE plastic in a coextruded tube or hose for handling fuels is a particularly desirable application of the present invention. It is further particularly desirable to use an ETFE plastic with carbonate chain ends as per U.S. Pat. Nos. 6,538,084, 6,680,124, and 6,740,375. This allows for a multilayer, multiwalled tube comprising an ETFE/FKM dynamic vulcanizate innermost layer, an ETFE barrier layer, and an outermost nylon or polyester (including nylon or polyester-based thermoplastic elastomers, such as HYTREL™ from DuPont or GRILLAMID™ from EMS-Grivory for example) layer for strength and abrasion resistance.

The inventive thermoplastic polymer composition including a dynamic vulcanizate thereof can be molded by using a general molding process and molding device. As for molding processes, optional processes, for example, injection molding, extrusion molding, compression molding, blow molding, calendar molding and vacuum molding can be adopted, and the thermoplastic polymer composition of the present invention is molded into a molded article in an optional shape according to an intended purpose.

Further, the present invention relates to a molded article formed from the inventive thermoplastic polymer composition and dynamic vulcanizate thereof, and the molded article encompasses a molded article in the form of sheet or film, and also a laminated article having a layer comprising the thermoplastic polymer composition of the present invention and a layer comprising another material.

In the laminated article having at least one layer comprising the thermoplastic polymer composition of the present invention and at least one layer comprising another material, appropriate material may be selected as the other material according to required properties and intended applications. Examples of the other material are, for instance, thermoplastic polymers such as polyolefin (for instance, high-density polyethylene, medium-density polyethylene, low-density polyethylene, linear low-density polyethylene, ethylene-propylene copolymer and polypropylene), nylon, polyester, vinyl chloride resin (PVC) and vinylidene chloride resin (PVDC), crosslinked rubbers such as ethylene-propylene-diene rubber, butyl rubber, nitrile rubber, silicone rubber and acrylic rubber, metals, glass, wood, ceramics, etc.

In the molded article having the laminated structure, a layer of an adhesive agent may be inserted between the layer comprising the thermoplastic polymer composition of the present invention and the substrate layer comprising other material. The layer comprising the thermoplastic polymer composition of the present invention and the substrate layer comprising other material can be adhered strongly and integrated by inserting a layer of an adhesive agent. Examples of the adhesive agent used in the layer of the adhesive agent are a diene polymer modified with acid anhydride; a polyolefin modified with acid anhydride; a mixture of a high molecular weight polyol (for example, polyester polyol obtained by polycondensation of a glycol compound such as ethylene glycol or propylene glycol with a dibasic acid such as adipic acid; a partly-saponified compound of a copolymer of vinyl acetate and vinyl chloride; or the like) and a polyisocyanate compound (for example, a reaction product of a glycol compound such as 1,6-hexamethylene glycol and a diisocyanate compound such as 2,4-tolylene diisocyanate in a molar ratio of 1 to 2; a reaction product of a triol compound such as trimethylolpropane and a diisocyanate compound such as 2,4-tolylenediisocyanate in a molar ratio of 1 to 3; or the like); and the like. Also, known processes such as co-extrusion, co-injection and extrusion coating can be used for forming a laminated structure.

The present invention encompasses a fuel hose or a fuel container comprising a single layer of the thermoplastic polymer composition of the present invention. The use of the fuel hose is not particularly limited, and examples thereof are a filler hose, an evaporation hose and a breather hose for an automobile. The use of the fuel container is not particularly limited, and examples thereof are a fuel container for an automobile, a fuel container for a two-wheel vehicle, a fuel container for a small electric generator, a fuel container for lawn mower and the like.

Also, the present invention encompasses a multilayer fuel hose or a multilayer fuel container comprising a layer of the thermoplastic polymer composition of the present invention. The multilayer fuel hose or the multilayer fuel container comprises the layer comprising the thermoplastic polymer composition of the present invention and at least one layer comprising the other material, and these layers are mutually adhered through or without an adhesion layer.

Examples of the layer of the other material are a layer comprising a rubber other than the thermoplastic polymer composition of the present invention and a layer comprising a thermoplastic resin.

Examples of the rubber are preferably at least one rubber selected from the group consisting of an acrylonitrile-butadiene rubber or a hydrogenated rubber thereof, a blend rubber of acrylonitrile-butadiene rubber and polyvinyl chloride, a fluororubber, an epichlorohydrin rubber and an acrylic rubber from the viewpoint of chemical resistance and flexibility. It is more preferable that the rubber is at least one rubber selected from the group consisting of an acrylonitrile-butadiene rubber or a hydrogenated rubber thereof, a blend rubber of acrylonitrile-butadiene rubber and polyvinyl chloride and a fluororubber.

The thermoplastic resin is preferably a thermoplastic resin comprising at least one selected from the group consisting of a fluororesin, a polyamide resin, a polyolefin resin, a polyester resin, a poly(vinyl alcohol) resin, a polyvinyl chloride resin and a poly(phenylene sulfide) resin from the viewpoint of fuel barrier property. It is more preferable that the thermoplastic resin is a thermoplastic resin comprising at least one selected from the group consisting of a fluororesin, a polyamide resin.

The fuel hose or the fuel container comprising a layer of the above described thermoplastic polymer composition of the present invention and a layer of other rubber or other thermoplastic resin is not particularly limited, and examples thereof are fuel hoses such as a filler hose, an evaporation hose and a breather hose for an automobile; and fuel containers such as a fuel container for an automobile, a fuel container for a two-wheel vehicle, a fuel container for a small electric generator and a fuel container for lawn mower.

A preferred fuel hose comprising a layer of the thermoplastic polymer composition of the present invention and a layer of the other rubber are a fuel hose composed of three layers of an outer layer comprising an acrylonitrile-butadiene rubber or a hydrogenated rubber thereof, or a blend rubber of acrylonitrile-butadiene rubber and polyvinyl chloride, a middle layer comprising the thermoplastic polymer composition of the present invention and an inner layer comprising a fluororubber, or a fuel hose composed of two layers of an outer layer comprising an acrylonitrile-butadiene rubber or a hydrogenated rubber thereof, or a blend rubber of acrylonitrile-butadiene rubber and polyvinyl chloride, and an inner layer comprising the thermoplastic polymer composition of the present invention from the viewpoint of excellent fuel barrier property, flexibility and chemical resistance.

The inventive thermoplastic polymer composition and dynamic vulcanizate thereof, and the molded article formed from the composition, are also suitably employed in the semiconductor manufacturing industry for equipment and applications (e.g., as an O (square) ring, a packing, a sealing material, a tube, a roll, a coating, a lining, a gasket, a diaphragm and a hose); in the automotive field (e.g., as a gasket, a shaft seal, a valve stem seal, a sealing material or a hose in engines, transmissions and fuel systems); in the aircraft, rocket and ship building industries; in chemical plants; and in general industrial fields.

### EXAMPLES

The invention is now described in yet further detail with respect to the following Examples and accompanying drawings. However, the present invention should not be construed as being limited thereto.

The major polymeric raw materials used in the Examples below, other than ETFE/FKM Polymer A and ETFE/FKM Polymer B (which are described above), are:
ETFE # 1 is a standard alternating copolymer of ethylene and tetrafluoroethylene, without any special reactive end groups. According to ASTM D3159, the melting temperature is 260-270° C., and the melt flow index is 8-16.
ETFE #2 is an alternating copolymer of ethylene and tetrafluoroethylene, with special reactive end groups per U.S. Pat. Nos. 6,538,084; 6,680,124; 6,740,375; 6,881,460; and/or 6,893,729, the above-noted patents incorporated herein by reference. According to ASTM D3159, the melting temperature is 250-260° C., and the melt flow index is 18-23.
ETFE #3 is an alternating copolymer of ethylene and tetrafluoroethylene primarily, but with enough hexafluoropropene (HFP) to lower its melting temperature, without any special reactive end groups. According to ASTM D3159, the melting temperature is 218-223° C., and the melt flow index is 20-35.
FKM #1 is a 66% fluorine dipolymer of vinylidene fluoride (VDF) and HFP. It has predominantly carboxylic acid end groups, and a Mooney viscosity at 121° C., large rotor, after a 10-minute run, of ˜25.
FKM #2 is a 66% fluorine copolymer of vinylidene fluoride (VDF) and HFP. It has predominantly carboxylic acid end groups, and a Mooney viscosity at 121° C., large rotor, after a 10-minute run, of ˜32.
FKM #3 is a 66% fluorine copolymer of vinylidene fluoride (VDF) and HFP. It has predominantly unreactive, non-acidic end groups, and a Mooney viscosity at 121° C., large rotor, after a 10-minute run, of ˜66.
PA-1 is a copolymer of ethylene and methylacrylate, EMAC SP-2268 from Eastman Chemical Company.
PA-2 is PARALOID K-175, a copolymer of methylmethacrylate, styrene, and butylacrylate that is primarily designed as a processing aid for PVC.
PA-3 is an ester-type internal lubricant (ADVALUBE E-2100 from Rohm and Haas) that is primarily designed as a processing aid for PVC.

Preliminary dynamic vulcanization experiments were carried out in a Brabender mixer, using conventional methods in which polymers, dispersions, and powders are added to the mixer. In this case, the mixing and dynamic vulcanization occurred between 225-250° C. in the Brabender Prep Center mixer with Banbury mix blades, using ETFE #3 which has an unusually low melting temperature for an ETFE polymer (˜220° C.), so as to slow down the curing reactions as much as possible using processing temperature alone. The batch factor was selected so that 68% of the volume inside the mixer was filled by the compound (238 cubic centimeter batch volume, a 68% fill factor; this same fill factor was used in all Brabender mixes reported herein). Two particular experimental recipes are shown in Table 1. It was noted that as soon as the Cure 20 (33% by weight BTPPC, dispersed in FKM) was added to the mixer, the torque began to increase, with no significant delay. In spite of this difficulty with the experimental methodology, Compound DV-2 showed significantly improved processability compared to Compound DV-1 (the control), indicating an effect of the ETFE/FKM block polymer (ETFE/FKM Polymer B) on the dynamic vulcanization process. Improved processability was shown by DV-2 coming out of the dynamic vulcanization process in large chunks and because DV-2 was smoother on the mill, whereas DV-1 came out as a fine powder. Curing had definitely begun before the Cure 20 had been thoroughly mixed with rest of the compound in the Brabender mixer, though, so the method and/or recipe needed to be modified to achieve a good quality dynamic vulcanizate. The bisphenol curative in this instance was bisphenol AF, in the form of a 50% by weight masterbatch in FKM known as “Cure 30”.

TABLE 1
Dynamically Vulcanized TPV Examples

| INGREDIENT: | DV-1 | DV-2 |
|---|---|---|
| ETFE/FKM Polymer B | — | 5.00 |
| ETFE #3 | 35.00 | 35.00 |
| FKM #1 | 62.60 | 57.60 |
| Cure 30 (50% bisphenol AF curative MB) | 3.20 | 3.20 |
| N-990 carbon black | 10.00 | 10.00 |
| Talc 9603S (talc, aminosilanized) | 7.00 | 7.00 |
| N-550 carbon black | 7.00 | 7.00 |
| Elastomag 170 (high activity MgO) | 10.00 | 10.00 |
| Add last (kicker) | | |
| Cure 20 (33% BTPPC phosphonium accelerator) | 1.20 | 1.20 |
| Total: | 136.00 | 136.00 |
| Specific Gravity: | 1.907 | 1.910 |

After several attempts to form dynamic vulcanizates of FKM in higher-melting ETFE polymers by adding curative chemicals directly into the hot Brabender mixer (as in Table 1), it was determined that this was not the best way to carry out the process. Dynamic vulcanization of ETFE/FKM can however be performed with direct addition of fast-acting cure system chemicals in a twin screw extruder or other such processing machine where dispersion of additives can occur very fast compared to an internal mixer like a Banbury or Brabender mixer.

Next bisphenol cure accelerators that produce significantly longer scorch delay than BTPPC were considered, and a series of experiments were carried out to discover workable methods for forming dynamic vulcanizates in which the cure system can be more rapidly mixed with the compound in the hot mixer prior to the onset of crosslinking in dynamic vulcanization. The method devised, referred to herein as the masterbatch method, was used for all subsequent experiments up through those described in Table 10. (U.S. Pat. No. 5,470,901 describes an alternative way to control crosslinking of FKM during high temperature dynamic vulcanization, but the method of this patent involves adding activator powders to the mixer at high temperature to initiate vulcanization; it is impossible to achieve good mixing of these powders prior to the onset of vulcanization.) First, however, the problem of identifying a slower FKM cure accelerator that nonetheless efficiently produces crosslinks was considered. Table 2 shows several alternative onium accelerators for the bisphenol curing of FKM and/or other bisphenol crosslinkable fluoroelastomers, from approximately 20 commercially available onium salts that were investigated. Table 2 shows that onium salts with low-nucleophilicity anions (iodide, methanesulfonate; see compounds FKX-4 and FKX-5 of Table 2) produced especially long scorch delay as measured by the Monsanto R-100 oscillating disc rheometer (ODR).

TABLE 2
Investigation of Alternative Onium Accelerators for Bisphenol Cure of FKM

| | FKX-1 | FKX-2 | FKX-3 | FKX-4 | FKX-5 |
|---|---|---|---|---|---|
| Ingredients: | | | | | |
| Fluorel FC 2145 (FKM dipolymer) | 92.50 | 92.50 | 92.50 | 92.50 | 92.50 |
| Cri-Act 45 (Cri-Tech activator masterbatch) | 13.50 | 13.50 | 13.50 | 13.50 | 13.50 |
| N-990 | 25.00 | 25.00 | 25.00 | 25.00 | 25.00 |
| Cure 30 (50% BPAF masterbatch in FKM) | 3.20 | 3.20 | 3.20 | 3.20 | 3.20 |
| Cure 20 (33.3% BTPPC in FKM) | 2.40 | — | — | — | — |
| BTPPC (benzyltriphenylphosphonium | — | 0.80 | — | — | — |
| chloride) | | | | | |
| ETPPBr (ethyltriphenylphosphonium | — | — | 0.80 | — | — |
| bromide) | | | | | |
| ETPPI (ethyltriphenylphosphonium) | — | — | — | 0.80 | — |
| DDAMS (distearyldimethylammonium | — | — | — | — | 0.80 |
| methanesulfonate) | | | | | |
| Comments: | Control | Control | bromide | iodide | Methosulfate |
| | #1 | #2 | | | |
| Monsanto R-100 ODR data, 177° C.: | | | | | |
| ML | 8.2 | 9.1 | 8.6 | 7 | 6.9 |
| MH | 89.4 | 90.3 | 83.9 | 79.2 | 65.8 |
| ts2 | 1.83 | 1.52 | 2.02 | 4.7 | 4.53 |
| t′50 | 2.72 | 2.33 | 3.12 | 7.75 | 6.7 |
| t′90 | 3.67 | 3.2 | 4.32 | 9.42 | 8.03 |
| t90-ts2 | 1.84 | 1.68 | 2.3 | 4.72 | 3.5 |
| Press Cured (10 minutes @ 177° C.): | | | | | |
| Shore A durometer | 65 | 66 | 66 | 65 | 65 |
| Tensile strength (MPa) | 8.26 | 7.10 | 8.53 | 6.16 | 6.90 |
| Elongation (%) | 318 | 265 | 290 | 232 | 391 |
| Stress at 100% strain (MPa) | 2.63 | 2.76 | 2.93 | 2.45 | 2.16 |
| Post-Cured Results (16 hours @ 232° C.): | | | | | |
| Shore A durometer | 69 | 69 | 73 | 71 | 71 |
| Tensile strength (MPa) | 11.46 | 11.75 | 9.98 | 10.98 | 10.81 |
| Elongation (%) | 210 | 234 | 153 | 187 | 249 |
| Stress at 100% strain (MPa) | 4.11 | 4.30 | 5.95 | 4.61 | 3.04 |

Table 2 presents data on two different versions of BTPPC onium accelerators. Both Viton™ Cure 20 (“Cure 20” herein) and pure BTPPC were studied. BTPPC is a toxic chemical, and also hydrophilic, so it is typically added to FKM formulations in the form of a masterbatch, Cure 20. The slightly faster curing observed for pure BTPPC probably occurred because of moisture absorption by BTPPC during storage, prior to the preparation of sample FKX-2. Two accelerators with outstanding scorch delay, more than twice as long as BTPPC, were identified: ETPPI (ethyltriphenylphosphonium iodide), and DDAMS (distearyldimethylammonium methanesulfonate). In general, it has been observed that quaternary ammonium salts tend to be bad for FKM hot air aging, and in fact during an aging experiment (70 hours at 250° C.), FKX-5 was the only one of the compounds of Table 2 that developed surface cracks. Therefore, ETPPI was selected for further study as an onium accelerator for ETFE/FKM dynamic vulcanization, even though in terms elongation especially, DDAMS produced better physical properties (prior to aging).

It is noteworthy that iodide and methanesulfonate anions produced exceptional scorch delay. Note that FKX-4 (iodide salt) had significantly longer scorch delay than FKX-3 (containing the bromide salt of the same onium cation). It is believed that the key feature of both ETPPI and DDAMS is the low nucleophilicity of the anions, and that numerous other quaternary onium salts with improved scorch delay exist, including in particular onium salts of iodide, alkylsulfonates, and arylsulfonates. Particularly noteworthy examples of onium accelerators that are expected to also produce long scorch delay when used in a bisphenol cure system are benzyltriphenylphosphonium iodide, benzyltriphenylphosphonium methanesulfonate, and benzyltriphenylphosphonium toluenesulfonate (several isomers).

The masterbatch method guarantees that elastomer and plastic phase, as well as fillers, curatives, and activators, are uniformly mixed at the onset of dynamic vulcanization. It also minimizes batch-to-batch variability because an entire series of compounds are based on the same masterbatches. It allows powdered chemicals to be added rapidly and accurately to the heated mix chamber, even if they melt; this is important for all the cure system components, but especially important for those that melt at processing temperature, and most especially for the onium catalyst (BTPPC or ETPPI). Table 3 shows experiments that proved the value of the masterbatch method.

TABLE 3
Demonstration of Masterbatch Method

| Ingredients: | MB-1 | MB-2 | MB-3 | MB-4 | MB-5 | MB-6 | DV-3 | DV-4 |
|---|---|---|---|---|---|---|---|---|
| FKM #2 (FKM dipolymer) | 70.00 | 65.75 | — | — | — | — | — | — |
| ETFE/FKM Polymer A | — | 5.00 | — | — | — | — | — | — |
| ETFE #1 | 30.00 | 29.25 | — | — | — | — | — | — |
| Calcium oxide HP | 4.00 | 4.00 | — | — | — | — | — | — |
| Mistron Vapor R (talc) | 7.00 | 7.00 | — | — | — | — | — | — |
| N-990 | 13.00 | 13.00 | — | — | — | — | — | — |
| MB-1 | — | — | — | — | — | — | 82.51 | 82.51 |
| MB-2 | — | — | 124.00 | 124.00 | 124.00 | 124.00 | — | — |
| Bisphenol AF | — | — | 13.78 | — | — | — | — | — |
| BTPPC | — | — | — | 6.53 | — | — | — | — |
| ETPPI | — | — | — | — | 6.53 | — | — | — |
| Elastomag 170 (MgO) | — | — | — | — | — | 50.00 | — | — |
| MB-6 (32.47% MgO) | — | — | — | — | — | — | 15.00 | 15.00 |
| MB-3 (10% BPAF bisphenol) | — | — | — | — | — | — | 22.40 | 22.40 |
| MB-4 (5% BTPPC activator) | — | — | — | — | — | — | 11.20 | — |
| MB-5 (5% ETPPI activator) | — | — | — | — | — | — | — | 11.20 |
| Total: | 124.00 | 124.00 | 137.78 | 130.53 | 130.53 | 180.53 | 131.11 | 131.11 |

In the experiments of Table 3, which illustrate the methodology used for all subsequent experiments, MB-1 and MB-2 are melt blend masterbatches prepared above the melting temperature of the ETFE. In this particular case, these masterbatches were prepared in a laboratory BR Banbury mixer, using shear heating to melt the ETFE (cooling water 35° C., 80% fill factor, 220 RPM after all ingredients are in, dump temperature 275° C.). MB-1 and MB-2 could also be prepared in the Brabender mixer or any other suitable means for forming melt blends. MB-1 and MB-2 are readily processable on an open roll rubber mill after melt blending is completed. Rubber mill blending was used to prepare MB-3 to MB-6, at temperatures during blending below 85° C. DV-3 and DV-4 were prepared in the Brabender with small mix head and roller blades, at temperatures between 255-280° C. The ingredients of the DV compounds are in this case pre-dispersed in MB-2, which contains 5% ETFE/FKM Polymer A as a compatibilizer.

DV-3 and DV-4 compare two alternative quaternary phosphonium accelerators in ETFE/FKM dynamic vulcanization. In both experiments, the major component of the dynamic vulcanizate was MB-1, which is added first to the Brabender mixer. After this was mixing smoothly, MB-6 (which delivers 4.87 phr of MgO) was added; as soon as that was well-mixed (about 30 seconds), MB-3 was added, which delivers 2.24 phr of BPAF bisphenol crosslinker; at this point the melt mix became quite smoky. This was mixed for 20 seconds, then the last component of the cure system was added, the onium accelerators contained in either MB-4 or MB-5. At this point, the crosslinking system is complete. In the case of DV-3, which contains 0.56 phr of BTPPC from MB-4, the torque began to rise immediately, as was the case for DV-1 and DV-2 from Table 1; this is not desirable because the dynamic vulcanization begins before the accelerator has a chance to blend uniformly with the system. In the case of DV-4, which contains 0.56 phr of ETPPI from MB-4 (ETPPI is not normally used as an onium accelerator for bisphenol curing of fluoroelastomers; it is used in the curing of epoxy powder coatings primarily) the torque did not begin to rise immediately, but rather after a ˜30 second delay; this is desirable because the onium accelerator has a chance to blend with the system before the dynamic vulcanization begins. DV-4 had significantly improved processability compared to Compound DV-3, probably indicating an effect of the delayed onset of dynamic curing in the ETFE/FKM dynamic vulcanization process.

Table 4 gives several examples of the fluoro-TPVs of the present invention. All the examples in Table 4 have a 70:30 ratio of FKM to ETFE, but vary in terms of the content of ETFE/FKM Polymer A triblock TPE (ETFE/FKM/ETFE). (ETFE/FKM Polymer A is 85% by weight FKM, 15% by weight ETFE). The fluoro-TPVs of Table 4 were prepared in a Brabender mixer, using the masterbatch method illustrated by Table 3. Table 4 gives the compositions of the final formulations, rather than the full details of the intermediate masterbatches, which are similar to those illustrated in Table 3. These formulations can all be readily processed on a rubber mill or a callender well below the m.p. of the ETFE plastic, both before and after dynamic vulcanization.

TABLE 4
Examples of ETFE/FKM Dynamic Vulcanizates with High Block Polymer
Content

| INGREDIENT: | DV-4 | DV-5 | DV-6 | DV-7 | DV-8 | DV-9 | DV-10 | DV-11 | DV-12 |
|---|---|---|---|---|---|---|---|---|---|
| FKM #2 | 48.82 | 46.00 | 43.17 | 40.35 | 37.53 | 34.71 | 31.89 | 29.06 | 26.24 |
| ETFE/FKM Polymer A | 24.92 | 28.24 | 31.56 | 34.88 | 38.20 | 41.52 | 44.84 | 48.16 | 51.48 |
| ETFE #1 | 26.26 | 25.76 | 25.27 | 24.77 | 24.27 | 23.77 | 23.27 | 22.78 | 22.28 |
| Talc | 7.00 | 7.00 | 7.00 | 7.00 | 7.00 | 7.00 | 7.00 | 7.00 | 7.00 |
| N-990 carbon black | 13.00 | 13.00 | 13.00 | 13.00 | 13.00 | 13.00 | 13.00 | 13.00 | 13.00 |
| Calcium oxide | 4.00 | 4.00 | 4.00 | 4.00 | 4.00 | 4.00 | 4.00 | 4.00 | 4.00 |
| Elastomag 170 (MgO) | 4.30 | 4.30 | 4.30 | 4.30 | 4.30 | 4.30 | 4.30 | 4.30 | 4.30 |
| Bisphenol AF | 2.24 | 2.24 | 2.24 | 2.24 | 2.24 | 2.24 | 2.24 | 2.24 | 2.24 |
| ETPPI | 0.56 | 0.56 | 0.56 | 0.56 | 0.56 | 0.56 | 0.56 | 0.56 | 0.56 |
| Total: | 131.10 | 131.10 | 131.10 | 131.10 | 131.10 | 131.10 | 131.10 | 131.10 | 131.10 |
| Calculated Specific Gravity: | 1.871 | 1.874 | 1.877 | 1.879 | 1.882 | 1.884 | 1.887 | 1.890 | 1.892 |
| Tensile Strength, Mpa | 9.47 | 12.50 | 10.81 | 17.70 | 16.21 | 13.09 | 19.27 | 19.51 | 19.30 |
| Tensile Elongation | 53% | 60% | 62% | 120% | 107% | 57% | 153% | 135% | 164% |
| Shore A Durometer | 92 | 92 | 90 | 88 | 88 | 91 | 89 | 83 | 83 |
| Measured Specifc Gravity | 1.879 | 1.881 | 1.884 | 1.887 | 1.892 | 1.893 | 1.893 | 1.896 | 1.902 |
| 10% Modulus, Mpa | 4.68 | 4.98 | 4.48 | 4.54 | 4.61 | 5.63 | 4.28 | 4.63 | 4.29 |
| 50% Modulus, Mpa | 10.26 | 10.98 | 9.84 | 10.54 | 10.45 | 12.99 | 9.69 | 11.10 | 9.86 |

Notes:
(1) Bisphenol AF is hexafluorobisphenol A (CAS # 1478-61-1)
(2) ETPPI is ethyltriphenylphosphonium iodide (ETPPI, CAS # 4736-60-1)

The formulations of Table 4 cover a range of ETFE/FKM Polymer A content from about 25% to about 50.5% of the total polymer content. The data indicate significant improvement in properties as the ETFE/FKM Polymer A content is raised from 25% to 35%, and thereafter a gradual improvement as the level increases further. There was however a lot of scatter in the data. Based on this data, further testing at 35% ETFE/FKM Polymer A was performed, but varying the levels of BPAF curative.

A series of compounds with fixed ETFE/FKM Polymer A level (35% of the total polymer) and fixed filler, activator (MgO), and onium salt accelerator (ETPPI) levels was prepared, in which the content of bisphenol curative (BPAF) and the type of ETFE were varied. The recipes are shown in Tables 5, 6, and 7. Table 5 shows the actual masterbatch method used to produce the compounds and two examples of actual compounds, as they were made. There are two series of compounds, which are identical except that one is based on ETFE #1 (DV-13 through DV-18), while the other series (DV-19 through DV-24) is based on ETFE #2. Table 6 shows (DV-13 through DV-18), both as actually prepared and the phr levels of key components. Table 7 shows (DV-19 through DV-24), both as actually prepared and the phr levels of key components.

TABLE 5
Actual Masterbatch Method Formulations of DV-13 to DV-24

| | MB-7 | MB-8 | MB-9 | MB-10 | MB-11 | DV-18 | DV-24 |
|---|---|---|---|---|---|---|---|
| FKM #3 | 37.75 | 37.75 | | | | | |
| ETFE/FKM Polymer A | 35.00 | 35.00 | | | | | |
| ETFE #1 (homopolymer) | 24.75 | — | | | | | |
| ETFE #2 (copolymer) | — | 24.75 | | | | | |
| N-550 | 5.00 | 5.00 | | | | | |
| Talc 9603S (talc, aminosilanized) | 6.00 | 6.00 | | | | | |
| Celite 350 | 3.00 | 3.00 | | | | | |
| Calcium oxide HP | 4.00 | 4.00 | | | | | |
| RF4-48-92 masterbatch | | | 57.75 | 57.75 | 57.75 | | 94.32 |
| RF4-48-93 masterbatch | | | 57.75 | 57.75 | 57.75 | 94.32 | |
| RF4-48-123 (20% bisphenol masterbatch) | | | | | | 6.60 | 6.60 |
| RF4-48-124 (30% MgO masterbatch) | | | | | | 15.00 | 15.00 |
| RF4-48-125 (10% ETPPI masterbatch) | | | | | | 6.00 | 6.00 |
| Bisphenol AF (BPAF) | | | 28.88 | | | | |
| StarMag CX-150 (high activity MgO) | | | | 49.50 | | | |
| ETPPI Ethyltriphenylphosphonium iodide | | | | | 12.83 | | |
| Total: | 115.50 | 115.50 | 144.38 | 165.00 | 128.33 | 121.92 | 121.92 |
| Specific Gravity: | 1.883 | 1.888 | 1.793 | 2.151 | 1.838 | 1.909 | 1.909 |

The masterbatch method guarantees that elastomer and plastic phase, as well as fillers, curatives, and activators are uniformly mixed at the onset of dynamic vulcanization. It also minimizes batch-to-batch variability because an entire series of compounds are based on the same masterbatches. Crosslinking began about 10-40 seconds after addition of the ETPPI masterbatch (MB-11) in these recipes (depending on bisphenol level), and this is not enough time to put in ETPPI as a powder (it melts at mixer temperature) and get it evenly mixed before the onset of curing; adding it as masterbatch MB-11 allows for rapid incorporation and thorough mixing before the onset of dynamic vulcanization. Masterbatches MB-7 and MB-8 were made in a BR Banbury using viscous heating to melt the ETFE. The cure masterbatches (MB-9 through MB-11) were made from a 50/50 mixture of the Banbury masterbatches MB-7 and MB-8 and they were used in both series of dynamic vulcanizates (DV-13 through DV-18, Table 6; and DV-19 through DV-24, Table 7). The cure masterbatches (MB-9 through MB-11) were prepared (238 cubic centimeter batch volume, a 68% fill factor) in a Brabender Prep Center mixer with mixer body set at 40° C., with Banbury blades, followed by mill mixing on a room temperature 2-roll mill. Final stage dynamic vulcanizations were done in the small Brabender mixer with roller blades (41 cubic centimeter batch volume, a 68% fill factor) with mixer body set at 250° C. Following dynamic vulcanization, the TPVs were milled on the room temperature rubber mill (slightly warmed to about 40° C. by milling a “warm-up compound”), and compression molded at 270° C., followed by cooling in the mold.

TABLE 6
Dynamic Vulcanizates based on ETFE #1 with Increasing BPAF Levels

| | DV-13 | DV-14 | DV-15 | DV-16 | DV-17 | DV-18 |
|---|---|---|---|---|---|---|
| INGREDIENT: | | | | | | |
| MB-7 (ETFE #1 based) | 98.72 | 97.84 | 96.96 | 96.08 | 95.20 | 94.32 |
| MB-8 (ETFE #2 based) | — | — | — | — | — | — |
| MB-9 (20% BPAF masterbatch) | 1.10 | 2.20 | 3.30 | 4.40 | 5.50 | 6.60 |
| MB-10 (30% MgO masterbatch) | 15.00 | 15.00 | 15.00 | 15.00 | 15.00 | 15.00 |
| ADD LAST: | — | — | — | — | — | — |
| MB-11 (ETPPI masterbatch) | 6.00 | 6.00 | 6.00 | 6.00 | 6.00 | 6.00 |
| Total: | 120.82 | 121.04 | 121.26 | 121.48 | 121.70 | 121.92 |
| Equivalent phr levels in final DV: | | | | | | |
| FKM #3 | 37.75 | 37.75 | 37.75 | 37.75 | 37.75 | 37.75 |
| ETFE/FKM Polymer A | 35.00 | 35.00 | 35.00 | 35.00 | 35.00 | 35.00 |
| ETFE #1 | 22.95 | 22.86 | 22.76 | 22.67 | 22.58 | 22.48 |
| ETFE #2 | 1.80 | 1.89 | 1.99 | 2.08 | 2.18 | 2.27 |
| Bisphenol AF | 0.22 | 0.44 | 0.66 | 0.88 | 1.10 | 1.32 |

TABLE 7
Dynamic Vulcanizates based on ETFE #2 with Increasing Bisphenol Sulfone
Levels

| | DV-19 | DV-20 | DV-21 | DV-22 | DV-23 | DV-24 |
|---|---|---|---|---|---|---|
| INGREDIENT: | | | | | | |
| MB-7 (ETFE #1 based) | — | — | — | — | — | — |
| MB-8 (ETFE #2 based) | 98.72 | 97.84 | 96.96 | 96.08 | 95.20 | 94.32 |
| MB-9 (20% BPAF masterbatch) | 1.10 | 2.20 | 3.30 | 4.40 | 5.50 | 6.60 |
| MB-10 (30% MgO masterbatch) | 15.00 | 15.00 | 15.00 | 15.00 | 15.00 | 15.00 |
| ADD LAST: | — | — | — | — | — | — |
| MB-11 (ETPPI masterbatch) | 6.00 | 6.00 | 6.00 | 6.00 | 6.00 | 6.00 |
| Total: | 120.82 | 121.04 | 121.26 | 121.48 | 121.70 | 121.92 |
| Equivalent phr levels in final DV: | | | | | | |
| FKM #3 | 37.75 | 37.75 | 37.75 | 37.75 | 37.75 | 37.75 |
| ETFE/FKM Polymer A | 35.00 | 35.00 | 35.00 | 35.00 | 35.00 | 35.00 |
| ETFE #1 | 1.80 | 1.89 | 1.99 | 2.08 | 2.18 | 2.27 |
| ETFE #2 | 22.95 | 22.86 | 22.76 | 22.67 | 22.58 | 22.48 |
| Bisphenol AF | 0.22 | 0.44 | 0.66 | 0.88 | 1.10 | 1.32 |

Tables 6 and 7 summarize the important features of these two experimental series, which basically compare ETFE #1 and ETFE #2 in fluoro-TPVs. The compounds of Table 6 are based on ETFE #1, which is an ETFE dipolymer without reactive chain ends. The compounds of Table 7 are based on ETFE #2, which is an ETFE dipolymer with reactive chain ends, as described in U.S. Pat. Nos. 6,538,084; 6,680,124; 6,740,375; 6,881,460; and/or 6,893,729, the above-noted patents incorporated herein by reference. Because the cure masterbatches MB-9 through MB-11 were prepared using a 50/50 blend of MB-7 and MB-8, and therefore contain both ETFE #1 and ETFE #2, the series of both Table 6 and Table 7 contain minor amounts of the other grade of ETFE. Table 8 gives tensile test results obtained using ASTM D638 plastic testing methods, with micro-dumbbell specimens, at 50 mm/minute testing rate for the compounds of Tables 5, 6, and 7.

TABLE 8
Tensile Results for DV-13 through DV-24
(comparison of ETFE #1, ETFE #2)
ETFE #1 based experiments

| | | Young's | Tensile | | Energy Estimate |
|---|---|---|---|---|---|
| | Bisphenol | mod., | Strength, | Elon- | (tensile × |
| | AF phr | MPa | MPa | gation | elongation) |
| DV-13 | 0.22 | 47.6 | 9.9 | 153% | 15.1 |
| DV-14 | 0.44 | 62.9 | 18.4 | 136% | 25.0 |
| DV-15 | 0.66 | 66.7 | 17.8 | 125% | 22.3 |
| DV-16 | 0.88 | 54.6 | 15.4 | 124% | 19.1 |
| DV-17 | 1.10 | 64.2 | 20.6 | 141% | 29.0 |
| DV-18 | 1.32 | 59.6 | 17.0 | 113% | 19.2 |

ETFE #2 based experiments

| | | Young's | Tensile | | |
|---|---|---|---|---|---|
| | Bisphenol | mod., | Strength, | | (tensile × |
| | AF phr | MPa | MPa | Elongation | elongation) |
| DV-19 | 0.22 | 48.0 | 10.7 | 146% | 15.6 |
| DV-20 | 0.44 | 53.2 | 15.8 | 217% | 34.3 |
| DV-21 | 0.66 | 48.0 | 16.0 | 182% | 29.1 |
| DV-22 | 0.88 | 53.7 | 17.8 | 202% | 36.0 |
| DV-23 | 1.10 | 55.8 | 18.1 | 193% | 34.9 |
| DV-24 | 1.32 | 54.7 | 20.8 | 214% | 44.5 |

The most notable thing about the data of Table 8 is that both elongation and tensile strength for the ETFE #2 based TPVs increased as increasing levels of BPAF curative were used, which is rather surprising. In the absence of grafting, the expected results are like those actually obtained for ETFE #1 based TPVs: more crosslinking leads to lower elongation. In both cases, tensile strength is expected to rise to a maximum value and then begin to fall, as was observed for the ETFE #1 series. A range of BPAF levels was selected to bracket the optimum value, which was estimated to be about 1.1 phr; this seems to be the case for the ETFE #1 based TPVs. Apparently, a grafting reaction is occurring between ETFE #2 and FKM which is mediated by the cure system; more curing results in more grafting, which improves the TPVs enough to counteract the detrimental effect of crosslinking on elongation to break, at least for the range of BPAF levels studied here.

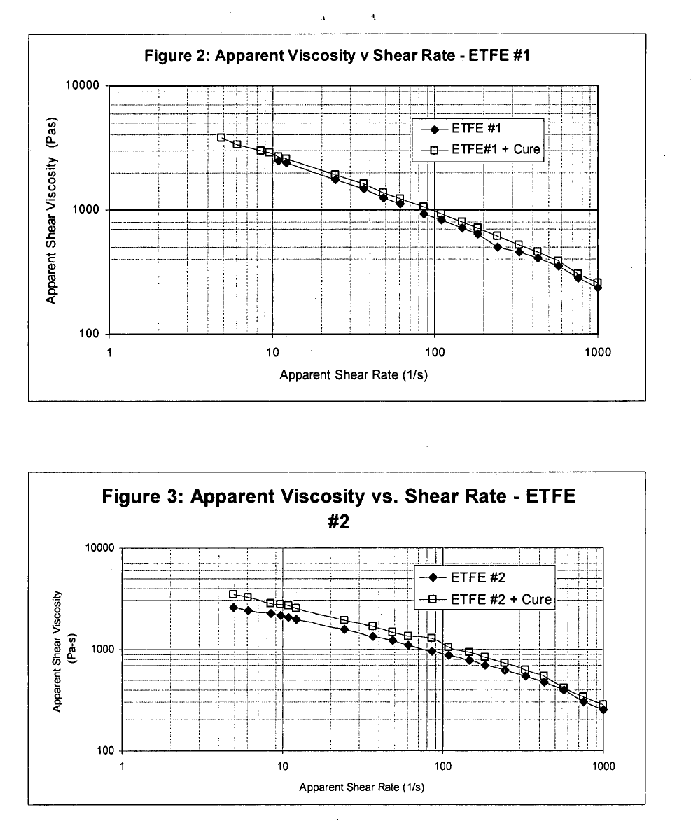

In order to test the hypothesis that a grafting reaction is occurring between ETFE #2 and the FKM phase involving the cure system, simple mixtures of ETFE with the cure system components (100 parts ETFE, 4.5 parts MgO, 1.0 part BPAF, 0.5 part ETPPI) were prepared. These mixtures were prepared in the small Brabender mix head; the mixing torque increased from 11 to 13 newton-meters for ETFE #2, but barely changed for ETFE #1. Next, capillary rheometry was run on the treated and untreated ETFEs (FIGS. 2 and 3), which clearly shows that the cure system increased the viscosity and molecular weight of ETFE #2, but had a negligible effect on ETFE #1. This is believed to be evidence that the bisphenol crosslinking system is reactive with the chain ends of ETFE #2.

The small effect on capillary rheometry seen in FIG. 2 is consistent with the filler effect of the fine particle size MgO used in the experiment. These results do not support an increase of molecular weight for ETFE #1 due to a chain extension reaction with BPAF.

FIG. 3 shows clear evidence of a chemical reaction of ETFE #2 with the FKM cure system. There is a small but clearly detectable increase in viscosity and molecular weight due to reaction with the cure system. It is believed that come of the polymer chains of ETFE became linked through a covalently bonded bisphenol “crosslink.”

The most significant thing about these results is that grafting of ETFE #2 with FKM is believed to generate ETFE/FKM block polymer compatibilizers in-situ. Based on the superior properties of DV-19 through DV-24 of Table 7 (based on ETFE #2) compared to the properties of the similar DV-13 through DV-18 (based on ETFE #1) of Table 6, and the data of FIGS. 2 and 3, it is apparent that the benefits of ETFE/FKM block polymer compatibilizers can be obtained through in situ reactions between ETFE polymers with reactive chain ends and bisphenol crosslinkable fluoroelastomers.

Bisphenol sulfone is known to produce bisphenol-crosslinked FKM that has good heat aging properties and thermal stability. The high melting temperature (m.p.) of bisphenol sulfone (246° C.) is problematic in FKM thermosets, but is not a problem at all in ETFE/FKM TPVs; in fact it is an advantage insofar as the high m.p. is correlated with much lower vapor pressure at ˜260-280° C., the typical temperature range for dynamic vulcanization in these systems. Bisphenol sulfone produces noticeably less smoke during dynamic vulcanization in a Brabender mixer than bisphenol AF. Table 9 shows a recipe that was used to evaluate the suitability of Bisphenol sulfone as a curing agent for ETFE/FKM dynamic vulcanizates. DV-25 of Table 9 is comparable to DV-24 described above in Tables 5, 6, 7, and 8, but uses bisphenol sulfone rather than bisphenol AF as the curative. The data on DV-24 in Table 9 is a replicate, not from the same test cited in Table 8. These compounds were replicated several times, and it was found to be important keep the maximum processing temperature below about 280° C.; when the materials get too hot during dynamic vulcanization or processing, the elongation to break is greatly reduced.

TABLE 9
Dynamic Vulcanizates Comparing Bisphenol AF to
Bisphenol Sulfone

| INGREDIENT: | DV-24 | DV-25 |
|---|---|---|
| MB-8 (ETFE #2 based) | 94.32 | 98.52 |
| MB-10 (30% MgO masterbatch) | 15.00 | 15.00 |
| MB-9 (20% bisphenol AF in MB-8) | 6.6 | |
| Bisphenol sulfone | | 1.20 |
| ADD LAST: | | |
| MB-11 (ETPPI masterbatch) | 6.00 | 7.20 |
| Total: | 121.92 | 121.92 |
| Physical Properties: | | |
| Stress at 10% strain (MPa): | 3.1 | 3.3 |
| Stress at 50% strain (MPa): | 8.1 | 7.8 |
| Tensile Strength (MPa): | 18.9 | 17.1 |
| Elongation to break: | 210% | 198% |

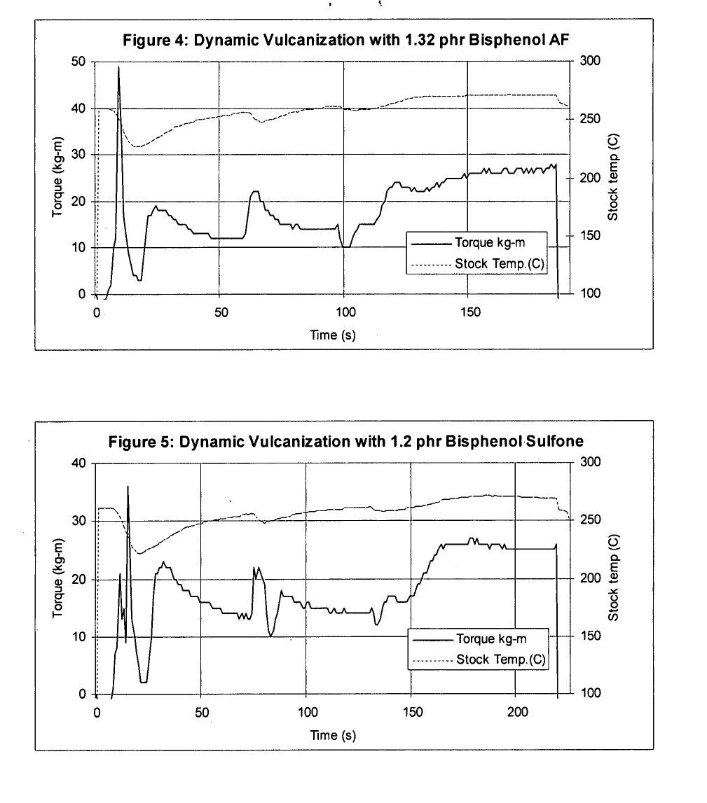

FIG. 5 is a Brabender trace of a dynamic vulcanization (DV-25) using bisphenol sulfone at 1.2 phr and ETPPI at 0.72 phr; the trace is very close to that of a similar compound (DV-24 of Table 7 and Table 9) which contains 1.32 phr of bisphenol AF and 0.60 phr of ETPPI, shown in FIG. 4.

Note: “124” in FIG. 5 refers to MB-10 of Table 4, the 30% MgO-containing masterbatch. “125” refers to MB-11 of Table 4. In this case, bisphenol sulfone was added as a powder along with MB-10. The dotted lines mark the points where addition is complete and the mixer is closed. The temporary sharp drop in mixing torque after addition of MB-10 and bisphenol sulfone is due to the melting of the bisphenol sulfone.

Comparing FIG. 5 to FIG. 4, note the slightly longer delay period before the onset of curing (after addition of MB-11) for bisphenol sulfone (FIG. 5) versus bisphenol AF (FIG. 4). Also, note that bisphenol sulfone cures a bit more slowly, even though a higher level of ETPPI accelerator was used. This is desirable, because time under shearing is required to effectively break up the FKM phase into a fine particulate. If the crosslinking reactions are too rapid, one gets relatively large crosslinked FKM particles which contain trapped ETFE domains. The “double humped” curing peak in FIG. 4 is seen sometimes; no consistent explanation has been found (it also occurs for some bisphenol sulfone-cured dynamic vulcanizates). Both bisphenol sulfone and bisphenol AF achieved similar maximum torque and physical properties. MB-9 and MB-10 of Table 4, the BPAF and MgO-containing masterbatches, were added at about 60 seconds in FIG. 4. As in FIG. 5, “125” refers to MB-11 of Table 4. The dotted line marks the point where addition of MB-11 is complete and the mixer is closed.

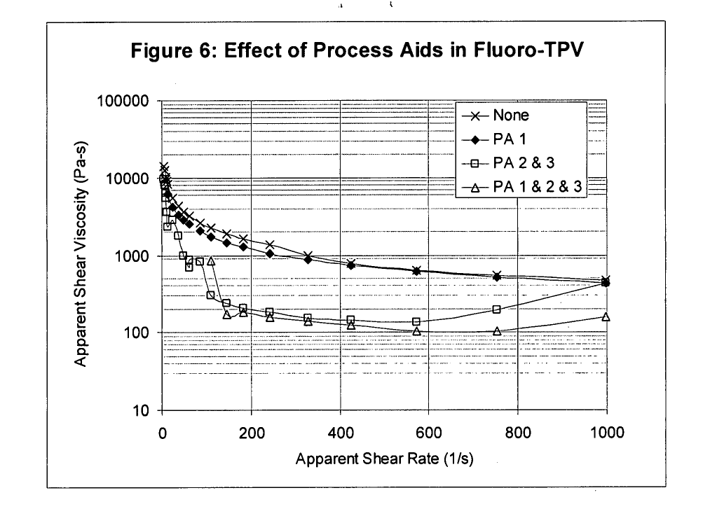

FIG. 6 shows data on apparent viscosity versus shear rate for a fluoro-TPV of the present invention, with and without added process aids. FIG. 6 is a semilog plot that covers the range of shear rate that is most important in extrusion (200-800 second⁻¹). The control in this case is DV-27, the formulation of which is shown below in Table 10. Table 10 shows that the activator and bisphenol curative can be combined in a single cure masterbatch (MB-13).

TABLE 10
Fluoro-TPV used to study Process Aids in FIG. 6

| INGREDIENT: | MB-12 | MB-13 | MB-14 | DV-27 |
|---|---|---|---|---|
| FKM #3 | 23.90 | — | — | — |
| ETFE/FKM Polymer A | 50.00 | — | — | — |
| ETFE #1 | 25.00 | — | — | — |
| N-550 carbon black | 5.00 | — | — | — |
| Talc 9603S (talc, aminosilanized) | 6.00 | — | — | — |
| Celite 350 | 3.00 | — | — | — |
| Calcium oxide HP | 4.00 | — | — | — |
| MB-12 | — | 116.90 | 116.90 | 101.76 |
| Elastomag 170 | — | 54.00 | — | — |
| Cure 30 (50% bisphenol AF | — | 26.40 | — | — |
| in FKM) | | | | |
| ETPPI (ethyltriphenylphosphonium | — | — | 12.99 | — |
| iodide) | | | | |
| MB-13 | — | — | — | 16.44 |
| MB-14 | — | — | — | 6.00 |
| Total: | 116.90 | 197.30 | 129.89 | 124.20 |

FIG. 6 shows that the effect of adding PA-1 (an ethylene/methylacrylate copolymer) at 0.5% by weight to DV-27 was negligible, resulting in no practical improvement in processability. PA-2 (a PVC process aid) at 0.5% in combination with PA-3 at 0.25% produced a large improvement in processability at moderate shear rates (200-600 seconds⁻¹), but the effect disappeared at higher shear rate (1000 second⁻¹). The combination of all three process aids (PA-1 at 0.5%, PA-2 at 0.5%, and PA-3 at 0.5%) produced the best improvement in processability, which was significant throughout the range of interest for extrusion. It was subsequently discovered that PA-2 at 0.7-0.9% by weight in combination with PA-3 at 0.04-0.06% by weight works very well. It was also found that the PA-2 and PA-3 process aids are only stable for about 5 minutes at 297° C. (the temperature at which capillary rheometry is typically performed on ETFE), but adding 0.1% by polymer weight of an antioxidant such as Irganox 1076, Irganox B-225 or Irganox 1010 can improve this period of stability to about 20 minutes at 297° C.

It should further be apparent to those skilled in the art that various changes in form and detail of the invention as shown and described above may be made. It is intended that such changes be included within the spirit and scope of the claims appended thereto.

What is claimed is:

1. A thermoplastic, moldable composition comprising a fluororesin (A) containing a fluorine-containing ethylenic polymer (a), a crosslinked fluororubber (B) including a fluororubber (b), at least part of the fluororubber (b) being chemically crosslinked, and a fluorine-containing thermoplastic elastomer (C),
wherein said fluorine-containing ethylenic polymer (a) comprises an ETFE copolymer, said fluororubber (b) comprises a FKM copolymer, and said fluorine-containing thermoplastic elastomer (C) is a block polymer comprising an elastomeric polymer segment (c-1) and a non-elastomeric polymer segment (c-2),
wherein said elastomeric polymer segment (c-1) comprises a FKM copolymer and said non-elastomeric polymer segment (c-2) comprises an ETFE copolymer, and
wherein said composition contains about 50-80 wt % of FKM copolymer and contains about 20-50 wt % of ETFE copolymer, including constituent segments of said block polymer, as a fraction of the total polymer contained in the composition.

2. The thermoplastic, moldable composition of claim 1, wherein the crosslinked fluororubber (B) is obtained by dynamically crosslinking the fluororubber (b) in the presence of the fluororesin (A), the fluorine-containing thermoplastic elastomer (C) and a crosslinking agent (D) under melt mixing conditions.

3. The thermoplastic, moldable composition of claim 1, comprising up to 2 wt % of polymeric processing aids and compounding ingredients.

4. The thermoplastic, moldable composition of claim 3, which contains about 0.5-1.0 wt % of a processing aid which is a copolymer of methyl-acrylate and/or methyl-methacrylate and butyl acrylate, as a fraction of the total polymer contained in the composition.

5. The thermoplastic, moldable composition of claim 4, further containing an oligomeric ester internal lubricant in an amount of about 0.01-0.10 wt % of the entire composition.

6. The thermoplastic, moldable composition of claim 1, containing about 5-60 wt % of an ETFE/FKM/ETFE triblock polymer as a fraction of the total polymer contained in the composition, wherein at least most of the FKM copolymer constituting said fluororubber (b) and a portion of the FKM center block of the ETFE/FKM/ETFE triblock polymer is crosslinked by a bisphenol or polyamine cure system.

7. The thermoplastic, moldable composition of claim 1, wherein most of the ETFE constituting the fluorine-containing ethylenic polymer (a) comprises ETFE having a reactive end-group.

8. The thermoplastic, moldable composition of claim 1, wherein the thermoplastic elastomer (C) comprises an ETFE/FKM diblock polymer.

9. The thermoplastic, moldable composition of claim 8, wherein the thermoplastic elastomer (C) comprises an ETFE/FKM diblock polymer in an amount of about 1-10 wt % as a fraction of the total polymer contained in the thermoplastic, moldable composition.

10. The thermoplastic, moldable composition of claim 8, wherein at least most of the FKM copolymer constituting the fluororubber (b) and a portion of the FKM block of the ETFE/FKM diblock polymer is crosslinked by a bisphenol or polyamine cure system.

11. The thermoplastic, moldable composition of claim 1, wherein at least most of the FKM copolymer constituting said fluororubber (b) and a portion of the FKM copolymer constituting thermoplastic elastomer (C) is crosslinked by a bisphenol cure system in which most or all of the bisphenol is bisphenol sulfone.

12. The thermoplastic, moldable composition of claim 11, wherein the crosslinking of the FKM copolymer is catalyzed by ethyltriphenylphosphonium iodide.

13. A fuel permeation-resistant hose including a layer comprising a fluoropolymer thermoplastic vulcanizate comprising a fluororesin (A) containing a fluorine-containing ethylenic polymer (a), a crosslinked fluororubber (B) including a fluororubber (b), at least most of the fluororubber (b) being chemically crosslinked, and a fluorine-containing thermoplastic elastomer (C),
wherein said fluorine-containing ethylenic polymer (a) comprises an ETFE copolymer, said fluororubber (b) comprises a FKM copolymer, and said fluorine-containing thermoplastic elastomer (C) is a block polymer comprising an elastomeric polymer segment (c-1) and a non-elastomeric polymer segment (c-2),
wherein said elastomeric polymer segment (c-1) comprises a FKM copolymer and said non-elastomeric polymer segment (c-2) comprises an ETFE copolymer, and
wherein said vulcanizate contains about 50-80 wt % of FKM copolymer and contains about 20-50 wt % of ETFE copolymer, including constituent segments of said block polymer, as a fraction of the total polymer contained in the vulcanizate.

14. The fuel permeation-resistant hose of claim 13, further including an outer ETFE layer.

15. The fuel permeation-resistant hose of claim 14, prepared by co-extruding the ETFE layer with the fluoropolymer thermoplastic vulcanizate.

16. The fuel permeation-resistant hose of claim 13, further comprising a layer of nylon extruded over the ETFE layer.

17. The fuel permeation-resistant hose of claim 14, further comprising a layer of a polyester-based block polymer thermoplastic elastomer extruded over the ETFE layer.

18. The fuel permeation-resistant hose of claim 14 further comprising a layer of a thermoset elastomer extruded over the ETFE layer.

19. A composition having reduced flex modulus obtained by melt blending the composition of claim 1 with additional ETFE.

20. A dynamic vulcanizate of a thermoplastic having a melting or minimum practical melt processing temperature of about 220-270° C. with FKM, wherein the FKM is dynamically vulcanized to crosslink the same via a bisphenol cure system catalyzed by an onium salt with a counter anion of low nucleophilicity.

21. The dynamic vulcanizate of claim 20, wherein crosslinking of the FKM is via a bisphenol cure system in which most or all of the bisphenol is bisphenol sulfone.

22. The dynamic vulcanizate of claim 20, wherein crosslinking of the FKM is catalyzed by ethyltriphenylphosphonium iodide.

23. The dynamic vulcanizate of claim 20, wherein the thermoplastic comprises polyphenylene sulfide.

24. The dynamic vulcanizate of claim 20, wherein the thermoplastic comprises a polyamide.
